(19) United States
(12) Patent Application Publication
(10) Pub. No.: US 2002/0165836 A1
(43) Pub. Date: Nov. 7, 2002

(54) Removable data carrier

(76) Inventors: Daniel Fluckiger, Munsingen (CH); Peter Stutz, Hinterkappelen (CH); Christian Moy, Grossaffoltern (CH)

Correspondence Address: PERMAN & GREEN, 425 POST ROAD, FAIRFIELD, CT, 06430, US

(21) Appl. No.: 10/081,317

(22) Filed: Feb. 21, 2002

Related U.S. Application Data
(60) Provisional application No. 60/270,796, filed on Feb. 23, 2001.
(60) Provisional application No. 60/277,806, filed on Mar. 22, 2001.
(60) Provisional application No. 60/277,841, filed on Mar. 22, 2001.
(60) Provisional application No. 60/277,873, filed on Mar. 22, 2001.
(60) Provisional application No. 60/277,931, filed on Mar. 22, 2001.
(60) Provisional application No. 60/277,946, filed on Mar. 22, 2001.
(60) Provisional application No. 60/338,892, filed on Nov. 5, 2001.

(51) Int. Cl. G06F 17/00

(52) U.S. Cl. 705/401

(57) ABSTRACT

A franking machine has an easily removable module. The module can comprise a flash memory for rapid updating when postal rates change. A RAM can also be used for additional data storage.

### (b) CROSS-REFERENCES TO RELATED APPLICATIONS

This application claims priority of the following U.S. provisional patent applications:

Serial No. 60/270,796 filed on Feb. 23, 2001,

Serial No. 60/277,806 filed on Mar. 22, 2001,

Serial No. 60/277,841 filed on Mar. 22, 2001,

Serial No. 60/277,873, filed on Mar. 22, 2001,

Serial No. 60/277,931 filed on Mar. 22, 2001,

Serial No. 60/277,946 filed on Mar. 22, 2001, and

Serial No. 60/338,892 filed on Nov. 5, 2001

### (c) STATEMENT REGARDING FEDERALLY SPONSORED RESEARCH OR DEVELOPMENT Not Applicable

### (d) BACKGROUND OF THE INVENTION

1. Field of the Invention

The present invention relates to a franking machine, and more particularly, to such a machine which has removable modules.

2. Description of the Related Art Including Information Disclosed Under 37 CFR 1.97 and 1.98

In previous franking machines, the vault, rate and application software modules, etc., were all buried inside the machine. To change or test the modules, e.g., when postal rates or software change, one had to open the covers of the machines and usually use tools, etc. This is time consuming and costly. The franking machine, because it contains in integral vault, had to remain secure for the post office to accept the accounting for postage. Physical changes to the franking machine were discouraged because they may have been considered significant enough to possible impair the security and accounting. One problem is that rates have to be changed periodically. Also, if a machine has to go into different countries, different rates would have to be loaded. One way to load rates was through a module that had electronic communication to the franking machine that remained secure. It is known to have a scale attached by wire to the franking machine, the scale having a removable rate card. It is also known to load information via diskette into a permanent memory in the franking machine through a disk drive and remove the diskette after the information has been downloaded into the permanent memory.

It is therefore desirable to have a franking machine with at least one easily updateable module.

### (e) BRIEF SUMMARY OF THE INVENTION

A franking machine comprises a circuit board located internal to the machine; and at least a first removable module electronically engageable with said circuit board, said first module including a flash memory.

### (f) BRIEF DESCRIPTION OF THE SEVERAL VIEWS OF THE DRAWING(S)

FIG. 1 is a block diagram of the invention; and

FIG. 2 is a block diagram of a franking machine.

### (g) DETAILED DESCRIPTION OF THE INVENTION

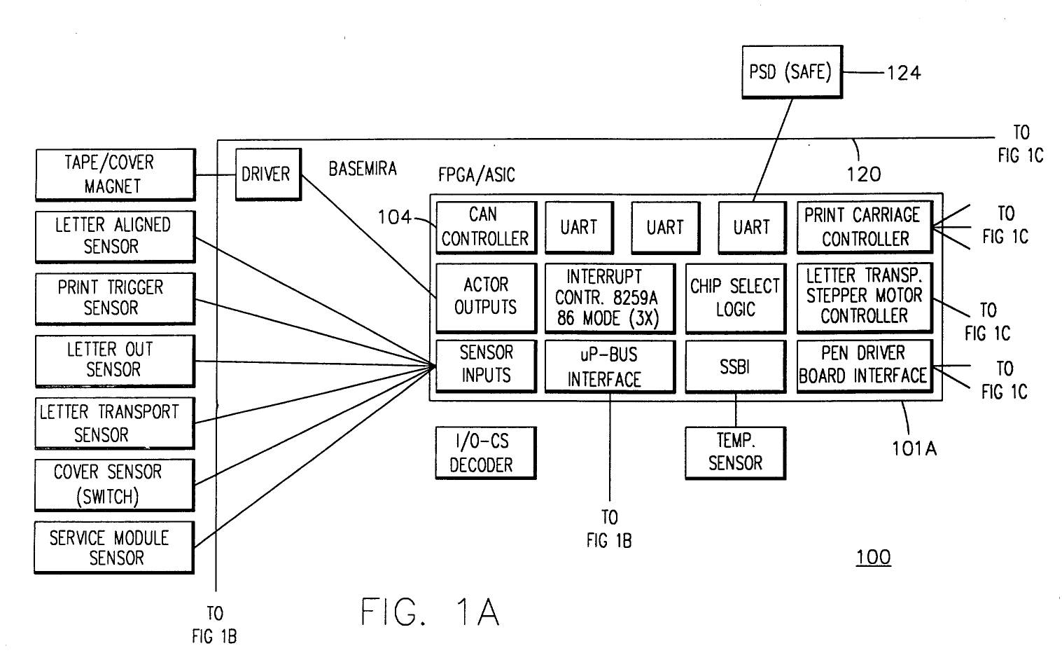

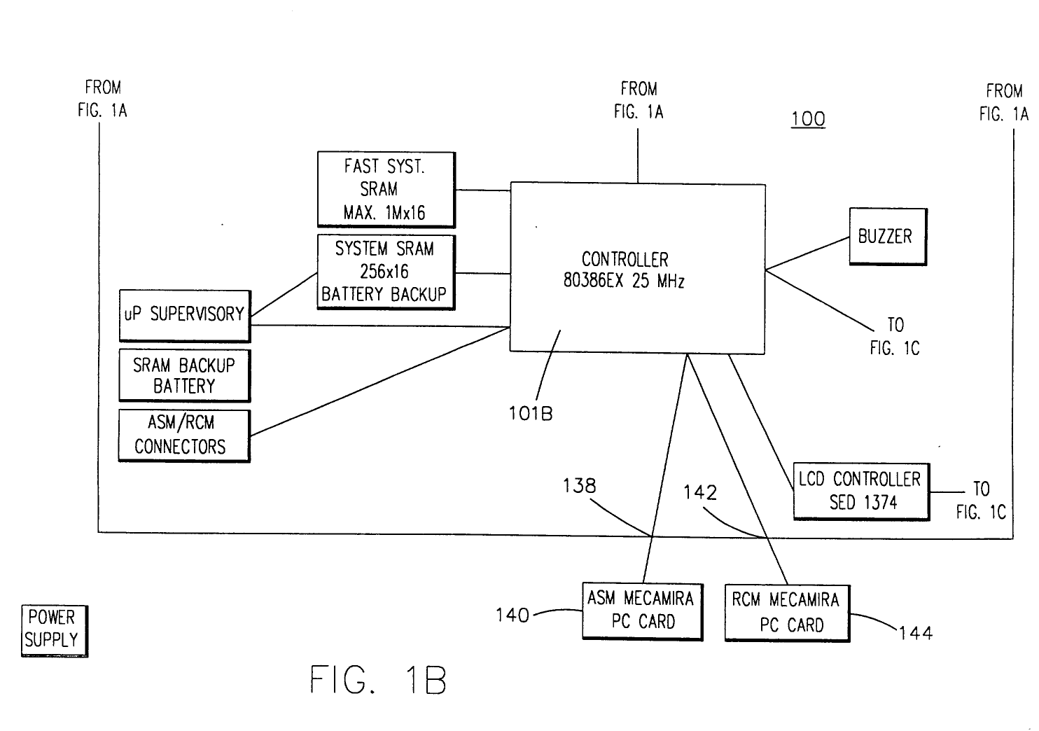

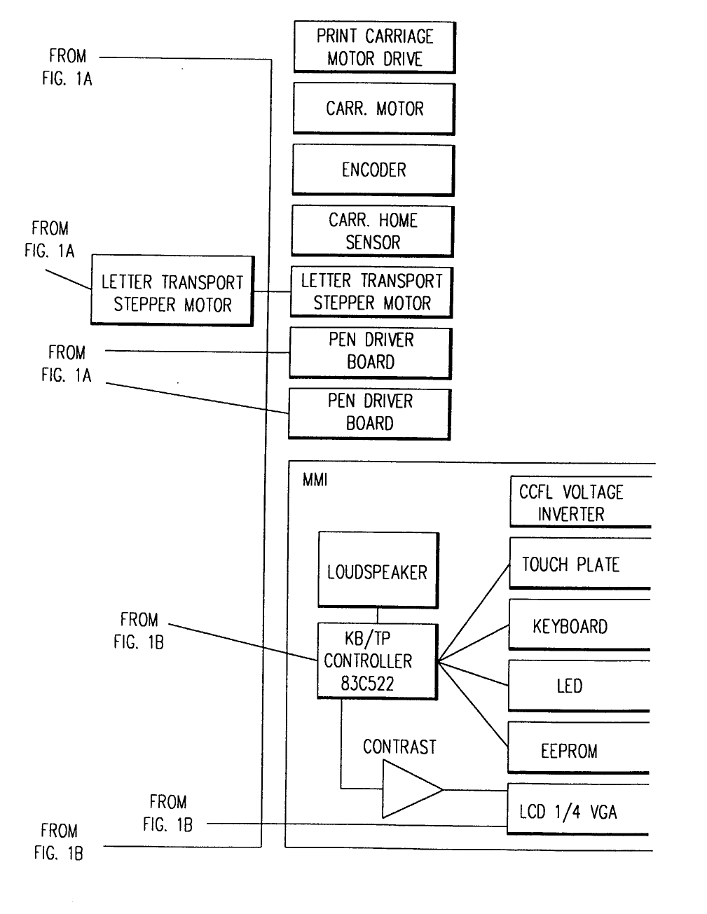

As shown in the machine block diagram (FIG. 1), the data ports are in two levels. On the main board one RS232 serial interface is implemented (together with the CAN connector as the Standard Communication Interface for the letter handling peripherals), while on the data communication module (separate board):

| | |
|---|---|
| Standard: | one RS232 serial interface and one |
| | parallel interface, or |
| Variants: | one parallel interface and Ethernet |
| | interface (RJ 45 connector) |

The Data Communication Module (DCM) is an ex works variant or field exchangeable under the machine housing.

In more detail, FIG. 1 shows a memory card or circuit board 100, which is normally disposed within a housing (not shown) of a franking machine. Board 100 has an ASIC 101a and a CPU (central processing unit) or controller 101b and a plurality of ports. The port of interest coupled to ASIC 101a is port 120, which allows UART 122 to communicate with PSU (postal security device or safe or vault) 124. PSU 124 is removable thereby allowing access to the various modules. The ports of interest coupled to controller 101bare port 138, which allows controller 101b to communicate with application software module (ASM) PC card 140; and port 142, which allows controller 110b to read rate module PC card 144. Card 144 can have a flash EEPROM and be easily removable from board 100 for quick and easy updating of postal rates, while ASM can have a SRAM for storing the type of program used, e.g., zone or point-to-point types of rate systems.

This invention can be used with a modular mailing system, and particularly with a digital modular mailing system that can be electronically customized to have a system that includes the users desired features (i.e. desired modules) within a customized mailing system.

Value metering devices are devices which in their most basic service, meter value. These devices take various forms such as, for example, postage meters (i.e. franking machines), various kinds of vending machines (i.e. lottery vending machines), tax stamp machines, various kinds of ticket dispensing machines, etc. Of these various devices, postage meters are a value metering device that dispense value in the form of postage, e.g. postage indicia, basically either as a stand-alone type postage meter or as part of a mailing system. The stand-alone type postage meter is basically a postage meter having its entire accounting system and security system positioned all in a single secure housing, the accounting system being mechanically coupled to the printing mechanism which prints the postage related indicia. A major issue with stand-alone postage meters is the overall time and cost for any repair or maintenance that needs to be done to the stand alone unit since any repair and/or maintenance needs to be done by technician who is certified to perform such work by properly opening the securely sealed housing of the postage meter, performing the repair and/or maintenance work, and then resecuring the postage meter once the work is completed. Thus, the overall labor cost is high and the overall time that the meter is not functioning is a relatively long amount of time, i.e. a long amount of downtime.

Besides the stand-alone type system as described above there are mailing systems which are basically formed of a mailing machine on which a postage meter is securely mounted. The postage meter is typically located in a securely sealed housing which contains the accounting and printing mechanisms. In the past few years both ink jet printing technology and smart card technology (i.e. smart cards used for securely housing the accounting circuitry of the postage meter) have been employed in these postage meters. The mailing machine systems with an electronic postage meter have enabled the users of such equipment to customize the exact type of mailing system they require by designing the overall mailing system in a modular fashion. One is able to set up a mailing system that will include individually removable mounted modules that can be added to or removed from the mailing system. For example, if one had a modular mailing system without an envelope stacker, one could add such a module to their system, and thereby have a mailing system that is able to stack envelopes once the postage has been placed on the envelopes fed into the system. If the stacker required repair, the stacker could easily be removed for repair since it is but one module within a modular system. Features such as inserters, feeders/separators, sealers, scales, addresses, stackers, etc. can be added to a postage meter to form different types of mailing systems.

It is desirable to have a mailing system that can be securely customized in a fast and reliable manner to control various kinds of external peripherals for handling envelopes. It is also desirable to be able to securely customize a mailing system in accordance with customer needs and connect various desired mail related peripherals to a mailing system without the need to provide a separate and dedicated port to achieve such a system.

From a manufacturing point of view, there are also several issues to consider. For example, when postage meters are used in a mailing machine, especially a modular mailing machine, there are many different components to be considered based upon customer requirements. Once a mailing machine with a postage meter is manufactured, the machine is not easily expanded. For instance, if a customer orders another component for their mailing machine, it is difficult to add the component to an existing machine. In addition, the devices used in mailing systems are usually specially designed to work with particular postage meters which tend to make them expensive to manufacture. Each device also has to have special programming to communicate with the postage meter, again increasing the cost of each device. In order to differentiate between each device for communication purposes, each device also requires a unique identifier programmed therein, and the postage meter. This further increases the cost to customize each device.

This invention can be used with a customized mailing system in which a module is capable of metering value but can hang a plurality of disabled operating features that are not available for use. The can use an authorization code for enabling certain designated operating features. The authorization code can be into the value metering module, whereby the desired combination of operating modules having the desired operating features could be placed in communication with a metering value module to create a desired modular mailing system.

The modular mailing system may have a value metering module having a plurality of disabled operating features, wherein the disabled operating features are not available for use; the ability to select at least one of the operating features from the plurality of disabled operating features for enabling such features; a parameter list for storing operating features; the ability to determine a unique serial number from at least one of the selected operating features and adding the unique serial number to the parameter list; the ability to generate an authorization code based on the parameter list for disabling the selected features of the value metering module; and the ability to enter the authorization code into the value metering module for the postage meter module can employ a system where initialization of the mailing system 10 occurs by inserting the PSD (postal security device) in the postage meter module 14; a small separate PSD (postal security device) that when engaged with the postage meter module enables the secure dispensing of funds and creates encrypted postage indicia. The PSD, when sent to the customer, contains all of the customer information preloaded by the manufacturer including postal code. In setup, the PSD is inserted into the postage meter and the postage meter as well as the other modular components such as feeder, moistener, stacker scale, etc. that are connected together are initialized. This is normally done through a communication link with the manufacturer such as by telephone. The postage indicia are printed based on the information in the PSD. In the prior art the “town circle” that denotes the location of the postage meter is normally provided by a die that has to be engraved. The setup in the mailing machine is therefore very easy and quick and completely controlled by the manufacturer. The PSD is inserted and the customer puts in the manufacturers telephone number and the system, through TMS (i.e. Tele Meter Setting) downloads the needed programs and parameters for the particular mailing system to get up and running. The initialization occurs with the first phone call.

In addition to the PSD, the customizable system can have at least one removable module electronically engageable with the franking machine, such as a circuit board interval to the machine, to provide further information to operate the franking machine is a particular configuration. This module can have, for instance, postal rate information stored therein. Additional such removable modules can be located in the franking machine. For instance, there can be a removable module electronically engageable with the franking machine for the provision of applications software. In another embodiment, a single such module may be used for postal rates as well as applications software, the information, for instance, provided in a single flash memory card.

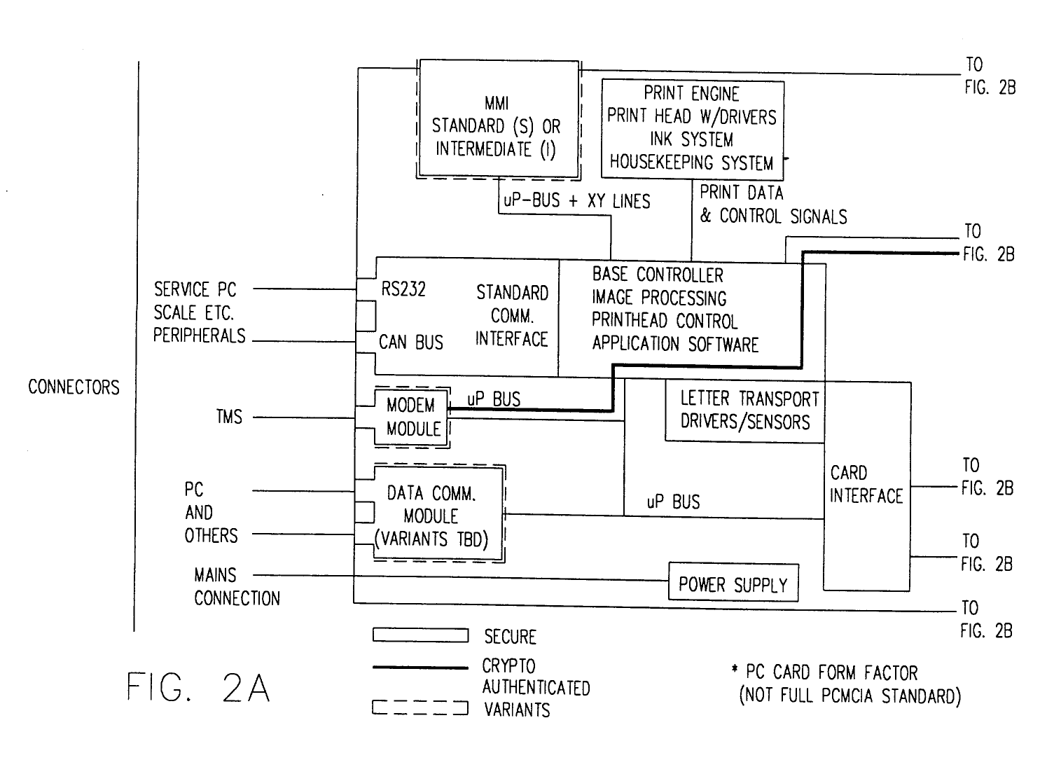

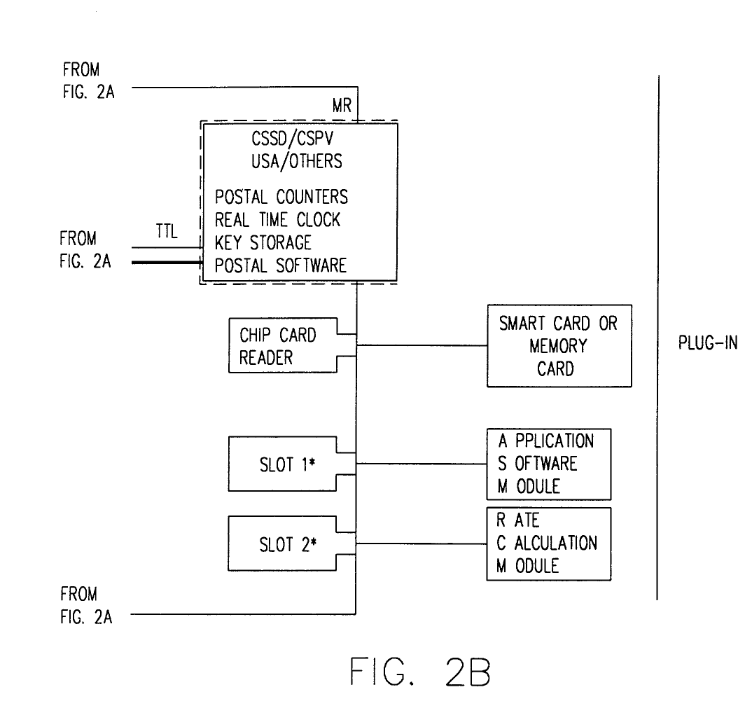

As shown in FIG. 2, the FM and the main letter handling peripherals (Feeders, Dyna Scale, Stackers) as well as the Address Module are connected by a CAN bus. For the ASM and the RCM module, the machine has 2 PCMCIA format slots. Preferably, for cost reasons, these are not full PCMCIA standard slots. Both the ASM and RCM will be insertable in either of the two slots. For connecting the system components outside the development program such as the legacy scales, the barcode reader, the printer and the local PC, the data interface described below will be used. To provide alignment for the letter flow, the modules are linked mechanically in a way that allows easy connection/disconnection by the user. As shown in att. 3, the interfaces are designed to allow the flexibility in combining the modules.

It will be appreciated that the invention has the following features:

A removal module containing flash memory and an optional RAM or an optional battery backed up non-volatile random access memory (NVRAM);

The flash card contains the application program of the franking machine and allows for easy software (SW) upgrade by the customer in case of SW bugs, or new functionality desired, new peripherals that are not supported by the installed SW; the SW upgrade is cost effective because no service intervention by a service technician is required;

The flash card contains postal rates that have to be updated from time to time according to postal requirements. By using the memory card, there is no need for any intervention by a service technician;

The flash card contains any possible extension of the standard SW (data or program code). Optional RAM on memory card is utilized to provide more RAM to the application SW or to the rates application or to any application SW extension contained in the flash memory;

The flash memory on the memory card can be reprogrammed while it is installed in the franking machine. Therefore a complete or partial update via remote access to data server is possible;

A subset of PCMCIA is utilized in order to have the benefit of low cost standard components (PCMCIA connectors and slots);

Thanks to the removable flash card that contains the application SW, it is possible to have specific test SW installed for manufacturing test and tests at the customer's site. Therefore, there is no need to install the application SW during the manufacturing process. It can be done immediately before installing the machine at the customer's site. As a consequence, there is no need for country-specific procedures during the manufacturing tests. In addition, the customer is always provided with the newest application SW.

Various aspects of the customizable value metering system are disclosed in the following four copending applications and each of these applications is incorporated by reference in its entirety in this application:

(1) U.S. Ser. No. ______, filed, ______, ______″ by ______ ______ ______+______, attorney docket 770P010633-US (PAR)

(2) U.S. Ser. No. ______, filed, ______, ______″ by ______ ______ ______+______, attorney docket 770P10638-US (PAR)

(3) U.S. Ser. No. ______, filed, ______, ______″ by ______ ______ ______+______, attorney docket 770P010689-US (PAR)

(4) U.S. Ser. No. ______, filed, ______, ______″ by ______ ______ ______+______, attorney docket 770P010693-US (PAR)

While the present invention has been particularly described with respect to preferred embodiments, it will be understood that the invention is not limited to these particular preferred embodiments, the process steps, the sequence, or the final structures depicted in the drawings. On the contrary, it is intended to cover all alternatives, modifications, and equivalents as may be included with the spirit within the spirit and scope of the invention defined by the appended claims. In addition, other methods and/or devices may be employed in the method and apparatus of the instant invention as claimed with similar results.

What is claimed is:

1. A franking machine comprising:
a circuit board located internal to the machine; and
at least a first removable module electronically engageable with said circuit board, said first module including a flash memory.

2. The machine of claim 1, wherein said memory has postal rate information stored therein.

3. The machine of claim 1, wherein said memory can be easily plugged into a computer.

4. The machine of claim 1, wherein said memory includes application software stored therein.

5. The machine of claim 1, wherein said module further comprises a RAM.

6. The machine of claim 1 further comprising a PSD.

7. The machine of claim 6, wherein said PSD is removable.

8. The machine of claim 1, further comprising:
a second removable module electronically engageable with said circuit board.

9. The machine of claim 8 wherein the second removable module includes application software stored therein.

10. A franking machine comprising a flash memory storing postal rate information and a RAM.
